(19) United States
(12) Patent Application Publication
(10) Pub. No.: US 2026/0346815 A1
(43) Pub. Date: Nov. 5, 2026

(54) NO AIR LOSS CHUCK

(71) Applicant: Steve Sasaki, Lodi, CA (US)

(72) Inventor: Steve Sasaki, Lodi, CA (US)

(21) Appl. No.: 19/198,992

(22) Filed: May 5, 2025

(51) Int. Cl. B60S 5/04; F16L 37/32

(52) U.S. Cl. CPC B60S 5/04; F16L 37/32

(57) ABSTRACT

A no air loss chuck. The no air loss chuck includes a nozzle, where the nozzle is configured to be placed on an air stem and a body, where the body is attached to the nozzle. The no air loss chuck also includes a collar, where the collar is outside the nozzle and configured to slide relative to the nozzle. The no air loss chuck further includes one or more locking teeth, the one or more locking teeth configured to engage the air stem and be pressed through the nozzle by the collar.

### CROSS-REFERENCE TO RELATED APPLICATIONS

Not applicable.

### BACKGROUND OF THE INVENTION

Air chucks are devices which are used to attach an air hose to an air stem of a tire. In many cases, and air hose is connected to an air tank or compressor and the air chuck is pressed against the air stem, creating a connection through which air can flow. For a single wheel, this works because the user is generally adding a small amount of air to a tire and so there isn't an inconvenience in doing so. In addition, small amounts of air loss may be inconsequential in many situations, such as inflating most tires.

However, there are some circumstances where even a tiny amount of air loss can lead to performance issues. For example, when adding gas to a shock absorber, the small amount of gas present means that during attachment or detachment using a conventional chuck, the loss of gas is enough to change the performance of the shock. Likewise, there are some times when a precise tire pressure needs to be achieved, such as in racing or aviation strut and tires or offroading.

The solution to this problem is the creation of no air loss chucks. The most common type of no air loss chuck uses a lever system. There is a spring biased lever that when pressed opens the mouth of the air chuck allowing it to be placed around an air stem. The lever is then released and the mouth closes, pinching the air stem. This works well, unless the air stem is difficult to reach, which is the case in many air stems for non-standard tire uses and other uses, such as shock absorbers.

Further, many off-roading wheels have “protected” air stems that are difficult to reach. Likewise, shock absorbers may not have much space between the air stem and surrounding objects. This means that both conventional air chucks and lever style no air loss chucks are unable to be placed on the air stem.

Accordingly, there is a need in the art for a no air loss chuck that can be used on wheels with hard to reach air stems, such as off-road wheels and shock absorbers.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a no air loss chuck. The no air loss chuck includes a nozzle, where the nozzle is configured to be placed on an air stem and a body, where the body is attached to the nozzle. The no air loss chuck also includes a collar, where the collar is outside the nozzle, configured to move the nozzle relative to the body, and a knurled surface on an exterior of the collar. The no air loss chuck further includes a pin, where the pin includes a knurled surface on an exterior of the pin, is configured to rotate relative to the body and nozzle, and is configured to engage the valve of the air stem creating airflow between the nozzle and the air stem. The no air loss chuck additionally includes an attachment, the attachment configured to receive gas from an external device.

Another example embodiment includes a no air loss chuck. The no air loss chuck includes a nozzle, where the nozzle is configured to be placed on an air stem and includes internal threading. The no air loss chuck also includes a gasket within the nozzle, where the gasket is configured to create a seal between the nozzle and the air stem, and a body, where the body is attached to the nozzle. The no air loss chuck also includes a collar, where the collar is outside the nozzle, and configured to move the nozzle relative to the body. The no air loss chuck further includes a collar nut, where the collar nut is on an exterior of the collar, includes a knurled surface, and includes a hex nut. The no air loss chuck further includes a pin, where the pin includes a knurled surface on an exterior of the pin, is configured to rotate relative to the body and nozzle, and includes a valve, the valve configured to engage the valve of the air stem creating airflow between the nozzle and the air stem. The no air loss chuck additionally includes an attachment, where the attachment includes internal threading which is configured to attach to an external device.

Another example embodiment includes an air delivery system. The air delivery system includes an air hose. The air delivery system also includes a no air loss chuck. The no air loss chuck includes a nozzle, where the nozzle is configured to be placed on an air stem and includes internal threading. The no air loss chuck also includes a gasket within the nozzle, where the gasket is configured to create a seal between the nozzle and the air stem, and a body, where the body is attached to the nozzle. The no air loss chuck also includes a collar, where the collar is outside the nozzle, and configured to move the nozzle relative to the body. The no air loss chuck further includes a collar nut, where the collar nut is on an exterior of the collar, includes a knurled surface, and includes a hex nut. The no air loss chuck further includes a pin, where the pin includes a knurled surface on an exterior of the pin, is configured to rotate relative to the body and nozzle, and includes a valve, the valve configured to engage the valve of the air stem creating airflow between the nozzle and the air stem. The no air loss chuck additionally includes an attachment, where the attachment is configured to connect to the air hose.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of an example of a no air loss chuck;

FIG. 1B illustrates a top view of the example of a no air loss chuck;

FIG. 1C illustrates an expanded view of the example of a no air loss chuck; and

FIG. 2 illustrates an example of a no air loss chuck attached to an air hose.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

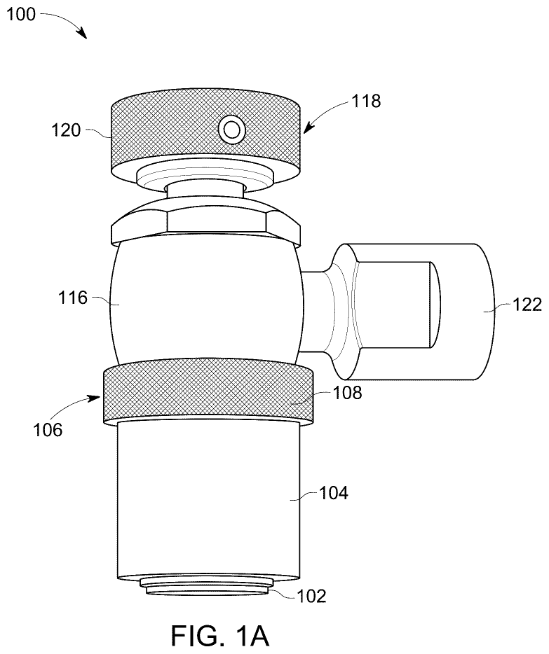

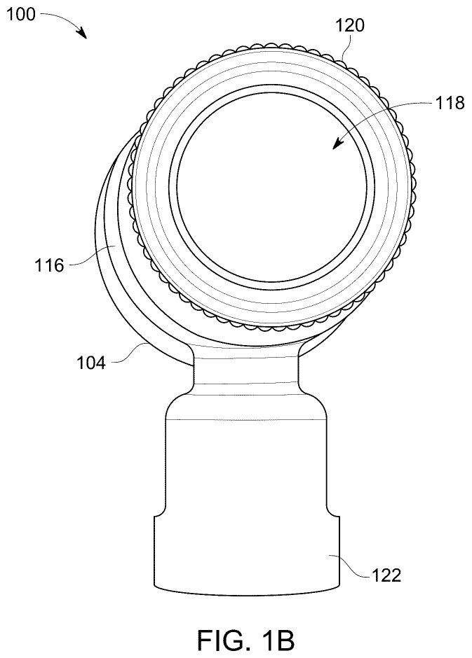

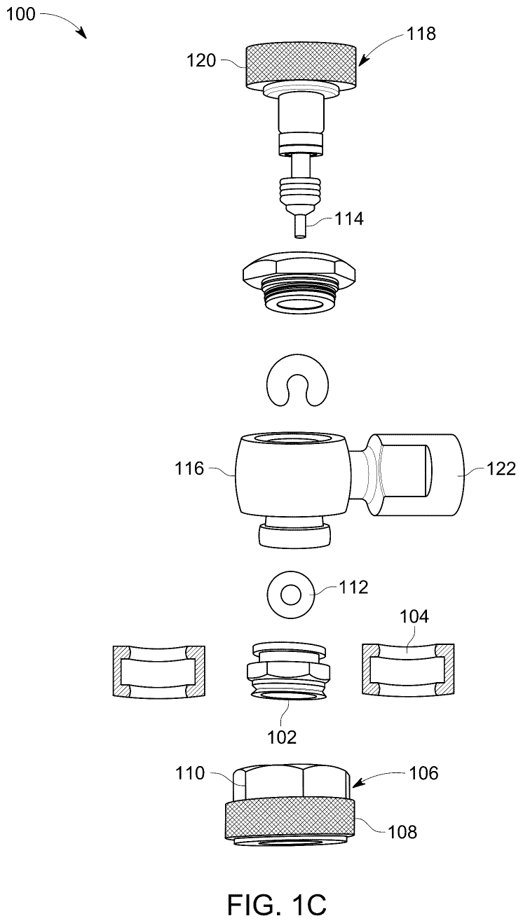

FIGS. 1A, 1B and 1C (collectively “Figure 1”) illustrates an example of a no air loss chuck 100. FIG. 1A illustrates a side view of an example of a no air loss chuck 100; FIG. 1B illustrates a top view of the example of a no air loss chuck 100; and FIG. 1C illustrates an expanded view of the example of a no air loss chuck 100. The no air loss chuck 100 attaches to the stem valve of a shock absorber. The benefit of a no air loss chuck 100 is that it remains in place without the user having to apply force and doesn't leak during high pressure applications, such as inflation of shock absorbers. Further, it allows attachment to or removal from the air stem without depression of the pin in the air stem, so no air or shock gas is lost during placement or removal.

FIG. 1 shows that the no air loss chuck 100 can include a nozzle 102. The nozzle 102 is configured to be placed around an air stem creating a direct connection between the no air loss chuck 100 and the air stem. The inner diameter of the nozzle 102 is larger than the outer diameter of the air stem, allowing the nozzle 102 to be placed over the air stem. The nozzle 102 can include internal threading, allowing it to be screwed onto the air stem. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

In particular, the nozzle 102 is configured to be placed on a Schrader valve. The nozzle 102 can include threading or other attachment means which allow the nozzle to attach to the Schrader valve. A Schrader valve consists of a valve stem into which a valve core is threaded. The valve core is a poppet valve assisted by a spring. A small rubber seal located on the core keeps the fluid or gas from escaping through the threads. A Schrader valve consists of an externally threaded hollow cylindrical metal tube, typically nickel-plated brass. In the center of the exterior end is a metal pin aligned with the long axis of the tube; the pin's end is approximately flush with the end of the valve body. All Schrader valves used on tires have threads and bodies of a single standard size at the exterior end, so caps and tools generally are universal for the valves on all common applications. The core of the valve can be removed or tightened with a tool.

FIG. 1 also shows that the no air loss chuck 100 can include a collar 104. The collar 104 is placed around the nozzle 102. That is, the inner surface of the collar 104 can surround the nozzle 102, allowing the entirety of the collar 104 to be outside of the nozzle 102 but allow the collar 104 to move (twist) the nozzle 102. This allows the collar 104 to move relative to the nozzle 102. In particular, this allows the collar 104 to be twisted and screw the nozzle 102 onto the tire stem.

FIG. 1 further shows that the collar 104 can include a collar nut 106. The collar nut allows the user to screw the nozzle 102 onto the valve stem. I.e., the collar nut 106 spins in place so that threads within the nozzle 102 screw onto the threads of the valve stem, creating a secure attachment between the two. In particular the collar nut 106 is turned until a seal is created between the no air loss chuck 100 and the valve stem.

FIG. 1 additionally shows that the collar nut 106 can include a knurled surface 108. This facilitates tightening of the collar nut 106 by hand. Knurling is a manufacturing process, typically conducted on a lathe, whereby a pattern of straight, angled or crossed lines is rolled into the material. The knurled surface 108 creates a high friction surface which is easily gripped by the finger tips of the user.

FIG. 1 moreover shows that the collar nut 106 can include a hex nut 110. the hex nut 110 allows a user to use a hand tools, such as a wrench or pliers, to tighten the collar nut 106 if so desired. For example, if the user wants to make sure the collar nut is very tight, he may hand tighten the collar nut 106 by hand using the knurled surface 108 then finish tightening the collar nut 106 using the hex nut 110. One of skill in the art will appreciate that for most uses, a wrench and a hex nut 110 are not needed and the knurled surface 108 is enough to create an air tight seal.

FIG. 1 additionally shows that the no air loss chuck 100 can include a gasket 112. The gasket 112 creates a seal between the no air loss chuck 100 and the air stem of a tire. I.e., the end of the tire air stem is pressed against the gasket 112. Currently no air loss chucks have a copper seal. This is because they were designed in the aviation industry and they were required to be rated to usage up to 3000 psi. That is not needed in other usages, such as shock recharging where pressures are from 200-600 psi. Therefore, for most usages, a more malleable material produces a better seal. For example, the gasket 112 can include Delrin, Teflon, UHMW (Ultra-high-molecular-weight polyethylene), or similar material and establishes a better seal between the no air loss chuck 100 and a tire air stem.

FIG. 1 moreover shows that the no air loss chuck 100 can include a valve 114. The valve 114 pushes on the valve of an air stem (which in turn pushes back on the valve 114), opening both the valve 114 and the air stem valve to allow air into or out of the tire. I.e., when both the valve 114 and the air stem valve are open, air can flow through the no air loss chuck 100 into or out of the tire via the air stem.

FIG. 1 further shows that the no air loss chuck 100 can include a body 116. The body 116 provides a base for each of the other parts. I.e., the body 116 is threaded onto the nozzle 102. The attachment of the body 116 and nozzle 102 creates a space for the collar 104 and allows the collar 104 to twist, screwing the nozzle onto the air stem.

FIG. 1 moreover shows that the no air loss chuck 100 can include a pin 118. The pin 118 presses the valve 114 onto the valve of the air stem, opening the valve of the air stem. This means that attachment of the no air loss chuck 100 and depressing the air stem valve are separate actions, ensuring that no gas flows during the attachment and removal steps. This allows the user to close the shock under pressure without gas loss during attachment or removal of the no air loss chuck 100.

FIG. 1 additionally shows that the pin 118 can include a knurled surface 120. This facilitates tightening of the pin 118 by hand. The knurled surface 120 creates a high friction surface which is easily gripped by the finger tips of the user. Most no air loss chucks use a T-handle which is more difficult to grip and is usually close to the body 116, making it difficult to turn.

FIG. 1 moreover shows that the no air loss chuck 100 can include an attachment 122. The attachment 122 allows the no air loss chuck 100 to be attached to an air hose. For example, the attachment 122 can include a threaded opening (female threads), allowing a connector to be threaded onto the attachment 122.

By way of example, a description of usage of the no air loss chuck 100 is included herein. The no air loss chuck 100 is placed with the nozzle 102 as far as possible on the stem valve of a tire. The collar 104 is turned by twisting the collar nut 106 without turning the body 116. The collar nut 106 is turned by the user using the knurled surface 108. If the user chooses, he/she may then tighten the connection even more using a wrench or pliers and the hex nut 110. This presses the gasket 112 against the top of the tire stem, preventing air loss, and the valve 114 near the valve of the air stem. The pin 118 is then turned using the knurled surface 120, pushing the valve 114 against the valve of the air stem, opening air flow between the no air loss chuck 100 (and any device, such as a nitrogen cartridge, connected to the attachment 122) allowing gas to flow. Thus, if a gas container is connected to the no air loss chuck 100, gas will not flow until the valve 114 is engaged by the pin 118.

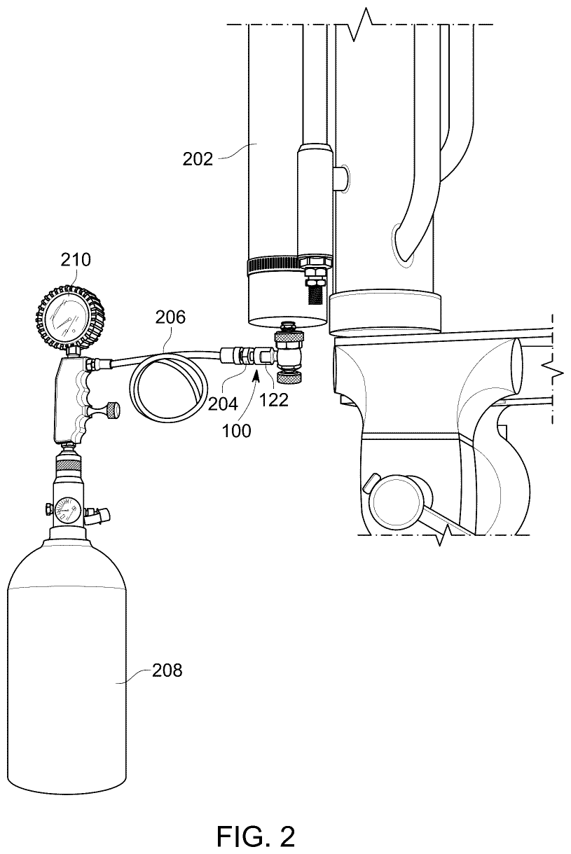

FIG. 2 illustrates an example of a no air loss chuck 100 attached to a shock 202. One of skill in the art will appreciate that the no air loss chuck 100 can be attached to any desired object and the shock 202 is used herein as exemplary. Air or other gas can flow through the no air loss chuck 100 to the shock 202.

FIG. 2 shows that an air hose connector 204 can be connected to the attachment 122. The hose connector 204 can include any desired connector such as a conventional chuck (aka a quick connect air coupler). The air hose connector 204 can be threaded onto the attachment of the no air loss connector 100. Because the no air loss connector 100 is disconnected from the shock 202 before the hose connector 204 is disconnected any air loss that occurs when the air hose connector 204 is disconnected won't matter because there won't be a loss of air in the shock 202.

FIG. 2 also shows that the air hose connector 204 can be connected to an air hose 206. The air hose 206 is connected to an external source of gas which flows through the air hose 206 and the air hose connector 204 into the no air loss chuck 100 and the shock absorber 202.

FIG. 2 further shows that the air hose 206 is connected to a compressed gas canister 208. The compressed gas cannister 208 is used herein but one of skill in the art will appreciate that the compressed gas canister 208 can be replaced by any desired source of gas, such as an air compressor. The compressed gas canister 208 contains any desired gas that is to be added to the shock absorber 202. Often, this gas is nitrogen but other gases may be used as well.

FIG. 2 moreover shows that an air gauge 210 can be connected between the compressed gas canister 208 and the air hose 206. This can show the pressure of the gas within the shock absorber 202 allowing the user to determine when to stop adding gas to the shock absorber 202.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A no air loss chuck, the no air loss chuck comprising:
a nozzle, wherein the nozzle is configured to be placed on an air stem;
a body, wherein the body is attached to the nozzle;
a collar, wherein the collar is:
outside the nozzle;
configured to move the nozzle relative to the body; and
a knurled surface on an exterior of the collar;
a pin, wherein the pin:
includes a knurled surface on an exterior of the pin;
is configured to rotate relative to the body and nozzle;
is configured to engage a valve of the air stem creating airflow between the nozzle and the air stem; and
an attachment, the attachment configured to receive gas from an external device.

2. The no air loss chuck of claim 1 wherein the nozzle includes an internal threading.

3. The no air loss chuck of claim 1 wherein the collar includes a collar nut.

4. The no air loss chuck of claim 3 wherein the collar nut includes a hex nut configured to enable tightening of the collar nut with a hand tool.

5. The no air loss chuck of claim 1 further comprising a gasket within the nozzle, wherein the gasket is configured to create a seal between the nozzle and the air stem.

6. The no air loss chuck of claim 5, wherein the gasket includes at least one of:
Delrin;
Teflon; or
Ultra-high-molecular-weight polyethylene;
wherein the gasket is rated for pressures between 200 and 600 psi.

7. The no air loss chuck of claim 1, wherein the attachment includes internal threading.

8. The no air loss chuck of claim 1, wherein the attachment includes external threading.

9. A no air loss chuck, the no air loss chuck comprising:
a nozzle, wherein the nozzle:
is configured to be placed on an air stem; and
includes internal threading;
a gasket within the nozzle, wherein the gasket is configured to create a seal between the nozzle and the air stem;
a body, wherein the body is attached to the nozzle;
a collar, wherein the collar is:
outside the nozzle; and
configured to move the nozzle relative to the body;
a collar nut, wherein the collar nut:
is on an exterior of the collar;
includes a knurled surface; and
includes a hex nut;
a pin, wherein the pin:
includes a knurled surface on an exterior of the pin;
is configured to rotate relative to the body and nozzle;
includes a valve, the valve configured to engage a valve of the air stem creating airflow between the nozzle and the air stem; and
a threaded port, wherein the threaded port includes internal threading which is configured to attach to an external device.

10. The no air loss chuck of claim 9, wherein the pin is threaded

11. An air delivery system, wherein the air delivery system comprises:
an air hose;
a no air loss chuck, the no air loss chuck including:
a nozzle, wherein the nozzle:
is configured to be placed on an air stem; and
includes internal threading;
a gasket within the nozzle, wherein the gasket is configured to create a seal between the nozzle and the air stem;
a body, wherein the body is attached to the nozzle;
a collar, wherein the collar is:
outside the nozzle; and
configured to move the nozzle relative to the body;
a collar nut, wherein the collar nut:
is on an exterior of the collar;
includes a knurled surface; and
includes a hex nut;
a pin, wherein the pin:
includes a knurled surface on an exterior of the pin;
is configured to rotate relative to the body and nozzle;
includes a valve, the valve configured to engage a valve of the air stem creating airflow between the nozzle and the air stem; and
an attachment, wherein the attachment is configured to connect to the air hose.

12. The air delivery system of claim 11 wherein the connection between the attachment and the air hose is a threaded connection.

13. The air delivery system of claim 11 further comprising:
a compressed gas tank;
wherein the air hose is configured to connect to the compressed gas tank.

14. The air delivery system of claim 13 wherein the compressed gas tank contains nitrogen gas.

15. The air delivery system of claim 11 wherein the attachment is configured to indirectly attach to the air hose.

16. The air delivery system of claim 15 wherein the indirect attachment between the attachment and the air hose is a quick connect air coupler.

17. The air delivery system of claim 16 wherein:
a female portion of the quick connect air coupler is connected to the air hose; and
a male portion of the quick connect air coupler is connected to the attachment.

18. The air delivery system of claim 17 wherein the male portion of the quick connect air coupler is threaded onto the attachment.

19. The air delivery system of claim 18 wherein the male portion of the quick connect air coupler includes external threading and the attachment includes internal threading.

20. The air delivery system of claim 11, further comprising:
an air gauge configured to measure a pressure of gas within an object connected to the no air loss chuck;
wherein the air gauge is connected between the air hose and the attachment.
